(19) United States
(12) Patent Application Publication
(10) Pub. No.: US 2011/0213698 A1
(43) Pub. Date: Sep. 1, 2011

(54) FINANCIAL SYSTEM HAVING INCREMENTAL DOLLAR RISK

(76) Inventor: Nick Celino, New South Wales (AU)

(21) Appl. No.: 13/125,314

(22) PCT Filed: Oct. 21, 2009
(86) PCT No.: PCT/AU2009/001384

§ 371 Date: Apr. 21, 2011

(30) Foreign Application Priority Data
Oct. 21, 2008 (AU) 2008905437

(51) Int. Cl. G06Q 40/00

(52) U.S. Cl. 705/38

(57) ABSTRACT

A method of comparing at least two purchase scenarios, the method comprising the steps of: determining a first cash flow analysis for a first mortgage scenario including a takeup of a first percentage of ownership of a mortgaged property; determining a potential first capital gain attributable to the first percentage of ownership; determining a second cash flow analysis for a second mortgage scenario for the same property with the second scenario having a takeup of a second percentage of ownership of the mortgage property; determining a potential second capital gain attributable to the second percentage of ownership; determining a first difference between the first and second cash flows; determining a second difference between the first and second capital gains determining the ratio of the second difference to the first difference.

### FIELD OF INVENTION

The present invention is directed to an effective method of providing a mortgage secured product. The present invention includes an effective method for marketing the mortgage based product.

### BACKGROUND

Financial institutions offer a sum of money at a preset rate in return for taking a mortgage over an asset such as a property asset. A mortgage is a form of asset in itself in that the mortgage over the property amounts to an ownership right over the property with the mortgage holder being able to exercise the security in the event that the mortgagor fails to meet repayment obligations.

In Australia, mortgage lending and negative gearing have become a significant part of the financial services industry. In this model, borrowers buy an asset and utilise the rental returns to offset the bank interest. A capital gain is often realised on the property purchase and sale.

The mortgage process has become quite common and commoditized and well understood. Normally, various rules of debt to valuation ratios are set by a bank in light of mortgage practice. The provision of the overall framework for mortgage lending products gives rise to new possibilities for financial products of significant benefit to users.

### SUMMARY OF THE INVENTION

It is an object of the present invention to provide for an improved form of mortgage type product and the marketing of such products.

In accordance with a first aspect of the present invention, there is provided a method of calculating an incremental dollar risk for an incremental dollar capital gain, the method comprising the steps of:

determining a first cash flow analysis for a first mortgage scenario including a takeup of a first percentage of a mortgaged property;
determining an incremental cash flow analysis for a second mortgage scenario for the same property with the second scenario having a takeup of a different percentage of the mortgage property;
determining a ratio of the difference in cash flow to the difference in takeup percentage as the incremental dollar risk for an incremental dollar capital gain.

In accordance with another aspect of the present invention, there is provided a method of comparing at least two purchase scenarios, the method comprising the steps of:
determining a first cash flow analysis for a first mortgage scenario including a takeup of a first percentage of ownership of a mortgaged property;
determining a potential first capital gain attributable to the first percentage of ownership;
determining a second cash flow analysis for a second mortgage scenario for the same property with the second scenario having a takeup of a second percentage of ownership of the mortgage property;
determining a potential second capital gain attributable to the second percentage of ownership;
determining a first difference between the first and second cash flows;
determining a second difference between the first and second capital gains
determining the ratio of the second difference to the first difference.

The potential capital gains determined may be real or unrealised capital gains.

Preferably the amount contributed in the first and second scenarios of a comparison are the same but may be different.

The interest rate for the mortgage in the first and second scenarios of a comparison may be the same but may be different.

The total amount borrowed for the mortgage in the first and second scenarios of a comparison may be the same but may be different.

The method may include carrying out multiple comparisons and comparing the ratios obtained.

Where multiple comparisons are made one or both of the scenarios in each comparison may be varied by varying at least one of:
the potential capital gain
possible expenses incurred whilst holding the property
possible income obtained whilst holding the property
period holding the property
borrower contribution
lender contribution
first percentage of ownership
second percentage of ownership,

At least one of the mortgage scenarios can be for a predetermined period and preferably can include a cash reserve buffer for meeting expected outgoings and optionally for possible contingencies during the life of the mortgage.

Preferably the cash reserve exceeds the expected outgoings.

In accordance with a further aspect of the present invention, there is provided a property portfolio management website including at least: a first accessible area including details of a user's actual property investments, the actual property investments including a predetermined percentage of a mortgaged property; a second accessible area including details of available property investments; a third accessible area showing a measure of simulated incremental dollar risk for an incremental dollar gain for a potential property investment.

The website preferably also includes at least one of: a property outlook area providing information on projected property outlooks for particular areas; or a question asking area for asking questions about property matters, or an incentive program system offering predetermined incentives for take up of available property investments.

In a further form there is provided a web site for selecting an ownership structure for purchase of a property from a plurality of possible ownership structures, the website including:
a first user input for selection of a first mortgage scenario including a takeup of a first percentage of ownership of a mortgaged property;
determining a potential first capital gain attributable to the first percentage of ownership;
a second user input for a selection of a second mortgage scenario for the same property with the second scenario having a takeup of a second percentage of ownership of the mortgage property;
means for determining a first cash flow analysis for said first mortgage scenario;
means for determining a potential first capital gain attributable to the first percentage of ownership;
means for determining a second cash flow analysis for said second mortgage scenario;
means for determining a potential second capital gain attributable to the second percentage of ownership;
means for determining a first difference between the first and second cash flows;
means for determining a second difference between the first and second capital gains, and
means for determining the ratio of the second difference to the first difference and displaying said ratio on said web site.

The web site may allow the user to vary the amount contributed in one or both of the first and second scenarios of a comparison.

The web site may allow the user to vary the interest rate for the mortgage in one or both of the first and second scenarios of a comparison.

The web site may allow the user to vary the total amount borrowed for the mortgage in one or both of the first and second scenarios of a comparison.

The web site may allow the user to carrying out multiple comparisons and to simultaneously display the multiple ratios obtained.

The web site may allow the user to vary at least one of:
the potential capital gain
possible expenses incurred whilst holding the property
possible income obtained whilst holding the property
period holding the property
borrower contribution
lender contribution
first percentage of ownership
second percentage of ownership,
for one or both of the scenarios in each comparison

The web site may include a user input area to enable a user to select one of said ownership structures, and for indicating a desire, willingness or commitment to purchasing said property with said selected ownership structure.

Unless the context clearly requires otherwise, throughout the description and the claims the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

Preferred embodiments of the present invention will now be described with reference to the accompanying drawings in which:

FIG. 1 to FIG. 12 illustrate various example template structures for the design of a website incorporating the concepts of the present invention;

FIG. 13 illustrates a template structure for illustrating the incremental dollar risk concept; and

FIG. 14 illustrates a table of the comparative advantages of smart mortgages formed in accordance with the preferred embodiment.

### DETAILED DESCRIPTION OF PREFERRED AND OTHER EMBODIMENTS

The preferred embodiments provide methods and systems of comparing different ownership and mortgage structures and a web based financial transaction system incorporating a seamless process of rental property investment allowing easy and convenient entry and exit for large numbers of fractional investors. The preferred embodiments also include a website for providing a fractional investor with up to date information on their investments. The website can provide access to rental property investments without restriction on the geographic location of the investment. The website also allows for planning “what if” scenarios on possible investments.

The preferred embodiment includes a number of significant market advantages including: 1) Fractional Ownership of rental properties; 2) A non recourse mortgage facility, developed in coordination with participating institutions, with nominal investments being a 60% loan to security value ratio with a built in 15% cash reserve on properties purchased.

In order to properly consider the operation of the preferred embodiment, the preferred embodiment will be discussed with reference to the standard mortgage product.

Turning initially to table 1 below, there is illustrated the funding sources and funding distribution involved in a traditional mortgage. In this arrangement, a property is purchased for $500,000. In the initial purchase, the purchaser contributes 30% with the lender contributing 75% respectively. There are costs associated with the purchase of 5%.

TABLE 1

| | | | Breakdown of funds | | |
|---|---|---|---|---|---|
| | | | distribution with a | | |
| | | | typical mortgage | | |
| Borrower | 30% | $150,000 | Associated costs | $25,000 | 5% |
| contribution | | | Equity contribution | $125,000 | 25% |
| Lender | 75% | $375,000 | Mortgage funding | $375,000 | 75% |
| contribution | | | | | |
| Total funding | 105% | $525,000 | | $525,000 | 105% |
| provided | | | | | |

In the loan structure of the preferred embodiment (hereinafter referred to as a SMART loan), for a $500,000 property, an initial contribution of $600,000 is formulated with the lender contributing 60% and the Borrower/Owner contributing 60%, including a cash reserve buffer of 15%.

TABLE 2

| | | | Breakdown of | | |
|---|---|---|---|---|---|
| | | | funds distribution | | |
| | | | with a S.M.A.R.T | | |
| | | | mortgage | | |
| Borrower | 60% | $300,000 | Cash Reserve | $75,000 | 15% |
| contribution | | | Associated costs | $25,000 | 5% |
| Lender | 45% | $300,000 | Equity contribution | $200,000 | 40% |
| contribution | | | Mortgage funding | $300,000 | 75% |
| Total funding | 120% | $600,000 | | $600,000 | 120% |
| provided | | | | | |

The two mortgages result in the illustrated distributions with the traditional loan requiring 105% total funding and the SMART loan requiring 120% total funding. The user portion of the funding of $300,000.00 can in turn be divided into multiple different sub-contributions from borrowers. In this case the division is into 10 sub lots of $30,000 each.

Simulated cash flow projections for a five year time span for the investment property with a purchase price of $500,00.00 are shown in tables 3 to 8. Table 8 shows the cumulative expenses incurred and various capital gains if the property is sold after three, four or five years and, after expenses, the capital gain returned to the owner or owners according to their ownership percentages. The projections are shown for a Traditional Mortgagor 50 having a 100% interest, a mortgage consortium holder having a 100% interest and a consortium mortgagor B having a 50% interest.

The projections are based on interest only mortgages. The interest rates are different because of the different ownership structure. Mortgage stamp duty is different due to the different amounts of the mortgages.

The figures for purchase costs and annual fees are merely examples and depending on the jurisdiction purchase costs and annual fees may vary.

TABLE 3
Current Mortgage Vs Consortium Mortgage Benefit Analysis (Year 1/5)

| | Traditional mortgagor A | | | Consortium | | | | | |
|---|---|---|---|---|---|---|---|---|---|
| | | Loan | | | | Loan | | | 50% |
| | | manage- | | | | manage- | | | consor- |
| | Purchase | ment | Mort- | Purchase | | ment | Mort- | Cash | tium |
| | costs | Cashflow | gage | costs | Equity | Cashflow | gage | reserve | member B |
| Purchase price | | | 500,000 | | | | 500,000 | | |
| Mortgage interest rate | | | 8.75% | | | | 9.50% | | |
| Consortium allocations | | | | 25,000 | 200,000 | | | 75,000 | |
| Total cash outlay | | 150,000 | | | | | | | 150,000 |
| Less: settlement expenses | | | | | | | | | |
| Upfront acquisition costs | | | | | | | | | |
| Stamp duty land transfer | −17,990 | | | −17,990 | | | | | |
| Mortgage stamp duty | −1,241 | | | −846 | | | | | |
| Land transfer rego + | −64 | | | −64 | | | | | |
| mortgage rego | | | | | | | | | |
| Land tax (.4% pa < $400k) | −400 | | | −400 | | | | | |
| (land worth $100k) | | | | | | | | | |
| Legal, finance, transfer rego, etc | −2,000 | | | −2,000 | | | | | |
| Purchase of shelf company | | | | −1,200 | | | | | |
| Mortgage consortium fee | | | | −2,500 | | | | | |
| Total acquisition costs | | −21,695 | | −25,000 | | | | | |
| Net deposit applied to property | | | 128,305 | | | | | | |
| purchase | | | | | | | | | |
| Settlement allocation 5% of $500k | | | | 25,000 | | | | | |
| Amount borrowed | | | 371,695 | | | | 300,000 | | |
| Year 1 investment cashflow | | | | | | | | | |
| Consortium cash reserve at | | | | | | | | 75,000 | |
| settlement | | | | | | | | | |
| End of year 1 cashflow position | | −150,000 | | | | | | | |
| Add: rental income | | 23,750 | | | | 23,750 | | | |
| (@ 5.0% pa × 95%) = | | | | | | | | | |
| ($25.0k × .95) | | | | | | | | | |
| Less: interest cost p a(int only | | −32,523 | | | | −28,500 | | | |
| mortgage) | | | | | | | | | |
| Less: repairs | | −500 | | | | −500 | | | |
| Mortgagor “A” cashflow | | −159,273 | | | | | | | |
| position (month 12) | | | | | | | | | |
| Consortium recurring expenses | | | | | | −5,250 | | | |
| Consortium cash reserve balance | | | | | | | | 69,750 | |
| end of yr 1 | | | | | | | | | |
| 50% consortium member B | | | | | | | | | 34,875 |
| cashflow position | | | | | | | | | Undistributed |
| | | | | | | | | | 115,125 |

TABLE 4
Current Mortgage Vs Consortium Mortgage Benefit Analysis (Year 2/5)

| | Traditional mortgagor A | | Consortium | | | |
|---|---|---|---|---|---|---|
| | Loan | | Loan | | | |
| | management | | management | | Cash | 50% consortium |
| | Cashflow | Mortgage | Cashflow | Mortgage | reserve | member B |
| BEGINNING BALANCE (CARRIED OVER FROM YEAR 1) | | | | | 69750 | |
| AMOUNT BORROWED | | 371695 | | 300000 | | |
| INVESTMENT CASHFLOW | | | | | | |
| INTEREST COST PER ANNUM (INT ONLY) | −32523 | | −28500 | | | |
| WATER + COUNCIL RATES | −1550 | | −1550 | | | |
| LAND TAX (BASED ON UNIMPROVED VALUE) | −400 | | −400 | | | |
| STRATA FEE/COMMUNITY LEVY | −3000 | | −3000 | | | |
| MANAGEMENT FEES | −1000 | | −1000 | | | |
| YEARLY CONSORTIUM FEE | | | −2500 | | | |
| REPAIRS | −500 | | −500 | | | |
| RENTAL INCOME (@ 5.0% PA @ 95%) ($25K × 95%) | 23750 | | 23750 | | | |
| TOTAL CASH OUTGOINGS FOR THE YEAR | −15223 | | −13700 | | | |
| CASH RESERVE BALANCE END OF YR 2 | | | | | 56050 | |
| AGGREGATE CASHFLOW POSITION | | | | | | |
| YEAR 1 OUTFLOW | −159273 | | −5250 | | | |
| YEAR 2 OUTFLOW | −15223 | | −13700 | | | |
| MORTGAGOR “A” CASHFLOW POSITION | −174496 | | | | | 28025 |
| TOTAL CASH RESERVE FUND OUTFLOW | | | −18950 | | | UNDISTRIBUTED |
| MORTGAGOR “B” CASH POSITION | | | | | | 121975 |

TABLE 5
Current Mortgage Vs Consortium Mortgage Benefit Analysis (Year 3/5)

| | Traditional mortgagor A | | Consortium | | | |
|---|---|---|---|---|---|---|
| | Loan | | Loan | | | |
| | management | | management | | Cash | 50% consortium |
| | Cashflow | Mortgage | Cashflow | Mortgage | reserve | member B |
| BEGINNING BALANCE (CARRIED OVER FROM YEAR 2) | | | | | 56050 | |
| AMOUNT BORROWED | | 371695 | | 300000 | | |
| INVESTMENT CASHFLOW | | | | | | |
| INTEREST COST PER ANNUM (INT ONLY) | −32523 | | −28500 | | | |
| WATER + COUNCIL RATES | −1550 | | −1550 | | | |
| LAND TAX (BASED ON UNIMPROVED VALUE) | −400 | | −400 | | | |
| STRATA FEE/COMMUNITY LEVY | −3000 | | −3000 | | | |
| MANAGEMENT FEES | −1000 | | −1000 | | | |
| YEARLY CONSORTIUM FEE | | | −2500 | | | |
| VALUATION | | | −350 | | | |
| REPAIRS | −500 | | −500 | | | |
| RENTAL INCOME (@ 5.0% PA @ 95%) ($25K × 95%) | 23750 | | 23750 | | | |
| TOTAL CASH OUTGOINGS FOR THE YEAR | −15223 | | −14050 | | | |
| CASH RESERVE BALANCE END OF YR 3 | | | | | 42000 | |
| AGGREGATE CASHFLOW POSITION | | | | | | |
| YEAR 1 OUTFLOW | −159273 | | −5250 | | | |
| YEAR 2 OUTFLOW | −15223 | | −13700 | | | |
| YEAR 3 OUTFLOW | −15223 | | −14050 | | | |
| MORTGAGOR “A” CASHFLOW POSITION | −189719 | | | | | 21000 |
| TOTAL CASH RESERVE FUND OUTFLOW | | | −33000 | | | UNDISTRIBUTED |
| MORTGAGOR “B CASH POSITION | | | | | | 129000 |

TABLE 6
Current Mortgage Vs Consortium Mortgage Benefit Analysis (Year 4/5)

| | Traditional mortgagor A | | Consortium | | | |
|---|---|---|---|---|---|---|
| | Loan | | Loan | | | |
| | management | | management | | Cash | 50% consortium |
| | Cashflow | Mortgage | Cashflow | Mortgage | reserve | member B |
| BEGINNING BALANCE (CARRIED OVER FROM YEAR 2) | | | | | 42,000 | |
| AMOUNT BORROWED | | 371695 | | 300000 | | |
| INVESTMENT CASHFLOW | | | | | | |
| INTEREST COST PER ANNUM (INT ONLY) | −32523 | | −28500 | | | |
| WATER + COUNCIL RATES | −1550 | | −1550 | | | |
| LAND TAX (BASED ON UNIMPROVED VALUE) | −400 | | −400 | | | |
| STRATA FEE/COMMUNITY LEVY | −3000 | | −3000 | | | |
| MANAGEMENT FEES | −1000 | | −1000 | | | |
| YEARLY CONSORTIUM FEE | | | −2500 | | | |
| REPAIRS | −500 | | −500 | | | |
| RENTAL INCOME (@ 5.0% PA @ 95%) ($25K × 95%) | 23750 | | 23750 | | | |
| TOTAL CASH OUTGOINGS FOR THE YEAR | −15223 | | −13700 | | | |
| CASH RESERVE BALANCE END OF YR 3 | | | | | 28,300 | |
| AGGREGATE CASHFLOW POSITION | | | | | | |
| YEAR 1 OUTFLOW | −159273 | | −5250 | | | |
| YEAR 2 OUTFLOW | −15223 | | −13700 | | | |
| YEAR 3 OUTFLOW | −15223 | | −14050 | | | |
| YEAR 4 OUTFLOW | −15223 | | −13,700 | | | |
| MORTGAGOR “A” CASHFLOW POSITION | −204,942 | | | | | 14,150 |
| TOTAL CASH RESERVE FUND OUTFLOW | | | −46,700 | | | UNDISTRIBUTED |
| MORTGAGOR “B CASH POSITION | | | | | | 135,850 |

TABLE 7
Current Mortgage Vs Consortium Mortgage Benefit Analysis (Year 5/5)

| | Traditional mortgagor a | | Consortium | | | |
|---|---|---|---|---|---|---|
| | Loan | | Loan | | | |
| | management | | management | | Cash | 50% consortium |
| | Cashflow | Mortgage | Cashflow | Mortgage | reserve | member b |
| Beginning balance (carried over from year 2) | | | | | 28,300 | |
| Amount borrowed | | 371695 | | 300000 | | |
| Investment cashflow | | | | | | |
| Interest cost per annum (int only) | −32523 | | −28500 | | | |
| Water + council rates | −1550 | | −1550 | | | |
| Land tax (based on unimproved value) | −400 | | −400 | | | |
| Strata fee/community levy | −3000 | | −3000 | | | |
| Management fees | −1000 | | −1000 | | | |
| Yearly consortium fee | | | −2500 | | | |
| Valuation | | | −350 | | | |
| Repairs | −500 | | −500 | | | |
| Rental income (@ 5.0% pa @ 95%) ($25k × 95%) | 23750 | | 23750 | | | |
| Total cash outgoings for the year | −15223 | | −14050 | | | |
| Cash reserve balance end of yr 3 | | | | | 14,600 | |
| Aggregate cashflow position | | | | | | |
| Year 1 outflow | −159273 | | −5250 | | | |
| Year 2 outflow | −15223 | | −13700 | | | |
| Year 3 outflow | −15223 | | −14050 | | | |
| Year 4 outflow | −15223 | | −13,700 | | | |
| Year 5 outflow | −15223 | | −13,700 | | | |
| Mortgagor “A” cashflow position | −220,165 | | | | | 7,300 |
| Total cash reserve fund outflow | | | −60,400 | | | Undistributed |
| Mortgagor “B” cash position | | | | | | 142,700 |

TABLE 8
Current Mortgage Vs Consortium Mortgage Benefit Analysis (Years 3 to 5)

| | | | | 50% consortium member B |
|---|---|---|---|---|
| | Traditional mortgagor A | | | 50% owner |
| | Year 3 | Year 4 | Year 5 | 50% share of total Capital gain |
| Mortgagor “A” cash outlay | $189,719.00 | $204,942.00 | $220,165.00 | |
| Mortgagor “B” cash outlay | $129,000.00 | $135,850.00 | $142,700.00 | |
| Mortgagor “A” incremental funding | $60,719.00 | $69,092.00 | $77,465.00 | |
| Sold for $550k or $50k capital gain | $50,000.00 | | | $25,000.00 |
| Mortgagor “A” advantage | $25,000.00 | | | |
| Incremental cashflow risked | $60,719.00 | $69,092.00 | $77,465.00 | |
| (incremental) dollar risked for incremental dollar capital gain | 60.7k/25.0k | 69.0k/25.0k | 77.4k/25k | |
| Incremental dollar risked for every incremental dollar capital gain | $2.42 | $2.76 | $3.09 | |
| Sold for $600k or $100k capital gain | $100,000.00 | | | $50,000.00 |
| Mortgagor “A” advantage | $50,000.00 | | | |
| Incremental cashflow risked | $60,719.00 | $69,092.00 | $77,465.00 | |
| (incremental) dollar risked for incremental dollar capital gain | 60.7k/50.0k | 69.0k/50.0k | 77.4k/50k | |
| Incremental dollar risked for every incremental dollar capital gain | $1.24 | $1.38 | $1.54 | |
| Sold for $700k or $200k capital gain | $200,000.00 | | | $100,000.00 |
| Mortgagor “A” advantage | $100,000.00 | | | |
| Incremental cashflow risked | $60,719.00 | $69,092.00 | $77,465.00 | |
| (incremental) dollar risked for incremental dollar capital gain | 60.7k/100.0k | 69.0k/100k | 77.4k/100k | |
| Incremental dollar risked for every incremental dollar capital gain | $0.60 | $0.69 | $0.77 | |
| Sold for $800k or $300k capital gain | $300,000.00 | | | $150,000.00 |
| Mortgagor “A” advantage | $150,000.00 | | | |
| Incremental cashflow risked | $60,719.00 | $69,092.00 | $77,465.00 | |
| (incremental) dollar risked for incremental dollar capital gain | 60.7k/150.0k | 69.0k/150k | 77.4k/150k | |
| Incremental dollar risked for every incremental dollar capital gain | $0.40 | $0.46 | $0.51 | |
| Sold for $1,000,000 or $500k capital gain | $500,000.00 | | | $250,000.00 |
| Mortgagor “A” advantage | $250,000.00 | | | |
| Incremental cashflow risked | $60,719.00 | $69,092.00 | $77,465.00 | |
| (incremental) dollar risked for incremental dollar capital gain | 60.7k/250.0k | 69.0k/250k | 77.4k/250k | |
| Incremental dollar risked for every incremental dollar capital gain | $0.24 | $0.27 | $0.30 | |

TABLE 9
Current Mortgage Vs 20% Consortium Mortgage Benefit Analysis (Years 3 to 5)

| | | | | 20% consortium member B |
|---|---|---|---|---|
| | Traditional mortgagor A | | | 20% owner |
| | Year 3 | Year 4 | Year 5 | 20% share of total Capital gain |
| Mortgagor “A” cash outlay | $189,719.00 | $204,942.00 | $220,165.00 | |
| Mortgagor “B” cash outlay | 51,600 | 54,340 | 57,080 | |
| Mortgagor “A” incremental funding | 138,119 | 150,602 | 163,085 | |
| Sold for $550k or $50k capital gain | 50000 | | | 10000 |
| Mortgagor “A” advantage | 40000 | | | |
| Incremental cashflow risked | 138119 | 150602 | 163085 | |
| (incremental) dollar risked for incremental dollar | 138.1K/40.0K | 150.6K/40.0K | 163.0K/40K | |
| capital gain | | | | |
| Incremental dollar risked for every incremental dollar | 3.45 | 3.75 | 4 | |
| capital gain | | | | |
| Sold for $600k or $100k capital gain | 100000 | | | 20000 |
| Mortgagor “A” advantage | 80000 | | | |
| Incremental cashflow risked | 138119 | 150602 | 163085 | |
| (incremental) dollar risked for incremental dollar | 138.1K/80.0K | 150.6K/80.0K | 163.0K/80K | |
| capital gain | | | | |
| Incremental dollar risked for every incremental dollar | 1.72 | 1.87 | 2.03 | |
| capital gain | | | | |
| Sold for $700k or $200k capital gain | 200000 | | | 40000 |
| Mortgagor “A” advantage | 160000 | | | |
| Incremental cashflow risked | 138119 | 150602 | 163085 | |
| (incremental) dollar risked for incremental dollar | 138.1K/160.0K | 150.6K/160.0K | 163.0K/160K | |
| capital gain | | | | |
| Incremental dollar risked for every incremental dollar | 0.86 | 0.93 | 1.01 | |
| capital gain | | | | |
| Sold for $800k or $300k capital gain | 300000 | | | 60000 |
| Mortgagor “A” advantage | 240000 | | | |
| Incremental cashflow risked | 138119 | 150602 | 163085 | |
| (incremental) dollar risked for incremental dollar | 138.1K/240.0K | 150.6K/240.0K | 163.0K/240.0K | |
| capital gain | | | | |
| Incremental dollar risked for every incremental dollar | 0.57 | 0.62 | 0.67 | |
| capital gain | | | | |
| Sold for $1,000,000 or $500k capital gain | 500000 | | | 100000 |
| Mortgagor “A” advantage | 400000 | | | |
| Incremental cashflow risked | 138119 | 150602 | 163085 | |
| (incremental) dollar risked for incremental dollar | 138.1K/400.0K | 150.6K/400.0K | 163.0K/400.0K | |
| capital gain | | | | |
| Incremental dollar risked for every incremental dollar | 0.34 | 0.37 | 0.4 | |
| capital gain | | | | |

TABLE 10
Tipping Point Calculations Current Mortgage Vs 50% Consortium Mortgage Benefit Analysis (Years 3 to 5)

| | Traditional mortgagor A | | |
|---|---|---|---|
| | Year 3 | Year 4 | Year 5 |
| B) break even point | | | |
| That point where mortgagor “A” incremental expenditure over equivalent time frame | 60719 | 69092 | 77465 |
| Equals his capital gain advantage over mortgagor “b” (on a proportionate basis). | 60.7k/60.7k | 69.0k/69.0k | 77.4k/77.4k |
| Incremental dollar risked for every incremental dollar capital gain | 1 | 1 | 1 |
| Sold for $654,930 or $154,930 capital gain | | | 154930 |
| Mortgagor “A” advantage (which equals 50% of capital gain achieved) | | | 77465 |
| Incremental cashflow risked | | | 77465 |
| (incremental) dollar risked for incremental dollar capital gain | | | 77.4k/77.4k |
| Incremental dollar risked for every incremental dollar capital gain | | | 1 |
| Sold for $638,180 or $138,180 capital gain | | 138,184 | |
| Mortgagor “A” advantage (which equals 50% of capital gain achieved) | | 69092 | |
| Incremental cashflow risked | | 69092 | |
| (incremental) dollar risked for incremental dollar capital gain | | 69.0k/69.0k | |
| Incremental dollar risked for every incremental dollar capital gain | | 1 | |
| Sold for $621,400 or $121,400 capital gain | 121400 | | |
| Mortgagor “A” advantage (which equals 50% of capital gain achieved) | 60700 | | |
| Incremental cashflow risked | 60700 | | |
| (incremental) dollar risked for incremental dollar capital gain | 60.7k/60.7k | | |
| Incremental dollar risked for every incremental dollar capital gain | 1 | | |
| Required property selling price to break even | | | |
| Mortgagor “A” incremental cashflow risked/.5 | $60,719/.50 | $69,092/.50 | $77,465/.50 |
| (or 50% share that mortgagor “B” has foregone) | | | |
| Resulting figure | $121.40 | $138.18 | $154.93 |
| Add original property purchase price of $500,000 | $500,000 | $500,000 | $500,000 |
| Break even selling price | $621,400 | $638,180 | $654,930 |
| C) selling price break even point rate of increase | | | |
| Break even capital gain value | $121.40 | $138.18 | $154.93 |
| Divide by the number of investment years | 3 | 4 | 5 |
| Resulting figure | $40,466 | $35,545 | $30,986 |
| Apply yearly capital gain achieved to purchase price | 40.4k/500k | 35.5k/500k | 30.9k/500k |
| Annual growth rate required by mortgagor “A” to break even with mortgagor “B” | 8.08% | 7.1% | 6.1% |

TABLE 11
Tipping Point Calculations Current Mortgage Vs 20% Consortium Mortgage Benefit Analysis (Years 3 to 5)

| | Traditional mortgagor A | | |
|---|---|---|---|
| | Year 3 | Year 4 | Year 5 |
| B) break even point | | | |
| That point where mortgagor “A” incremental expenditure over equivalent time frame | 138,119 | 150,602 | 163,085 |
| Equals his capital gain advantage over mortgagor “c” (on a proportionate basis). | 138.1k/138.1k | 150.6k/150.6k | 163.0k/163.0k |
| Incremental dollar risked for every incremental dollar capital gain | $1.00 | $1.00 | $1.00 |
| Sold for $703,856 or $203,856k capital gain | | | 203,856 |
| Mortgagor “A” advantage (which equals 80% of capital gain achieved) | | | 163,085 |
| Incremental cashflow risked | | | 163,085 |
| (incremental) dollar risked for incremental dollar capital gain | | | 163.0k/163.0k |
| Incremental dollar risked for every incremental dollar capital gain | | | $1.00 |
| Sold for $688,252 or $188,252 capital gain | | 188,252 | |
| Mortgagor “A” advantage (which equals 80% of capital gain achieved) | | 150,602 | |
| Incremental cashflow risked | | 150,602 | |
| (incremental) dollar risked for incremental dollar capital gain | | 150.6k/150.6.0k | |
| Incremental dollar risked for every incremental dollar capital gain | | $1.00 | |
| Sold for $672,500 or $172,500 capital gain | 172,500 | | |
| Mortgagor “A” advantage (which equals 80% of capital gain achieved) | 138,119 | | |
| Incremental cashflow risked | 138,119 | | |
| (incremental) dollar risked for incremental dollar capital gain | 138.1k/138.1k | | |
| Incremental dollar risked for every incremental dollar capital gain | $1.00 | | |
| Required property selling price to break even | | | |
| Mortgagor “A” incremental cashflow risked/.8 (or 80% share that | 138,119/.8 | 150,602/.8 | 163,085/.8 |
| mortgagor “c” has foregone) | | | |
| Resulting figure | 172,500 | 188,252 | 203,856 |
| Add original property purchase price of $500,000 | 500,000 | 500,000 | 500,000 |
| Break even selling price | 672,500 | 688,252 | 703,856 |
| C) selling price break even point rate of increase | | | |
| Break even capital gain value | 172,500 | 188,252 | 203,856 |
| Divide by the number of investment years | 3 | 4 | 5 |
| Resulting figure | 57,500 | 47,063 | 40,771 |
| Apply yearly capital gain achieved to purchase price | 57.5k/500k | 47.0k/500k | 40.7k/500k |
| Annual growth rate required by mortgagor “A” to break even with | 11.5% | 9.4% | 8.1% |
| mortgagor “C” | | | |

It can be seen that over the 5 year time frame projection of tables 3 to 8 that a substantially different end result ensues. This indicates that traditional Mortgagor A may be committing unnecessary funding expressed as an extra cost to acquire the portion he does not already own if he were mortgagor “B” under a consortium. As a result it is possible to project an Incremental Dollar Risked for every Incremental Dollar Capital Gain.

Table 8 shows three sets of comparisons. The difference between the two capital gains under the two scenarios is calculated.

The difference in cash flows between the two scenarios is also calculated.

The difference in cash flow is the extra amount of money that needs to be committed to earn the difference in capital gain. By dividing the difference in capital gain by the difference in cash flow we obtain a number that represents the amount in dollars that needs to be committed to earn each extra dollar of capital gain. This is referred to as the incremental dollar risk for an incremental dollar capital gain.

As seen in FIG. 8, for the same capital gain when the property is sold the incremental dollar risk varies with when the property is sold. For sale with different capital gains the incremental dollar risk also varies.

The incremental dollar risk varies also varies with the percentage ownership in the consortium. Table 9 shows similar calculations as table 8 but the consortium member B only owns 20% of the property. Compared to a 20% owner, the 100% traditional owner risks $4.00 for each extra dollar capital gain if the property is sold after 5 years for a capital gain of $50,000.00. In comparison, compared to a 50% owner the 100% traditional owner risks $3.09 for each extra dollar capital gain if the property is sold after 5 years for a capital gain of $50,000.00.

As capital gain increases the incremental dollar risk reduces. We can use this to determine which ownership/mortgage structure is better. This depends on the individual. However, once the value falls below 1.00, the traditional method provides a greater incremental capital gain for each extra dollar committed. In some ways this is a tipping point at which one would change from selecting one route over the other.

We can also calculate what capital gain over different periods is required to have a value of 1.00 and tables 10 and 11 show these figures for the 50% and 20% consortium member.

This incremental dollar risk index can be plotted for projected time periods and projected capital gain scenarios in order to determine an optimal investment of a contributor's money, thereby providing an optimal leverage scenario. The plotted information can be displayed in a table or graph format.

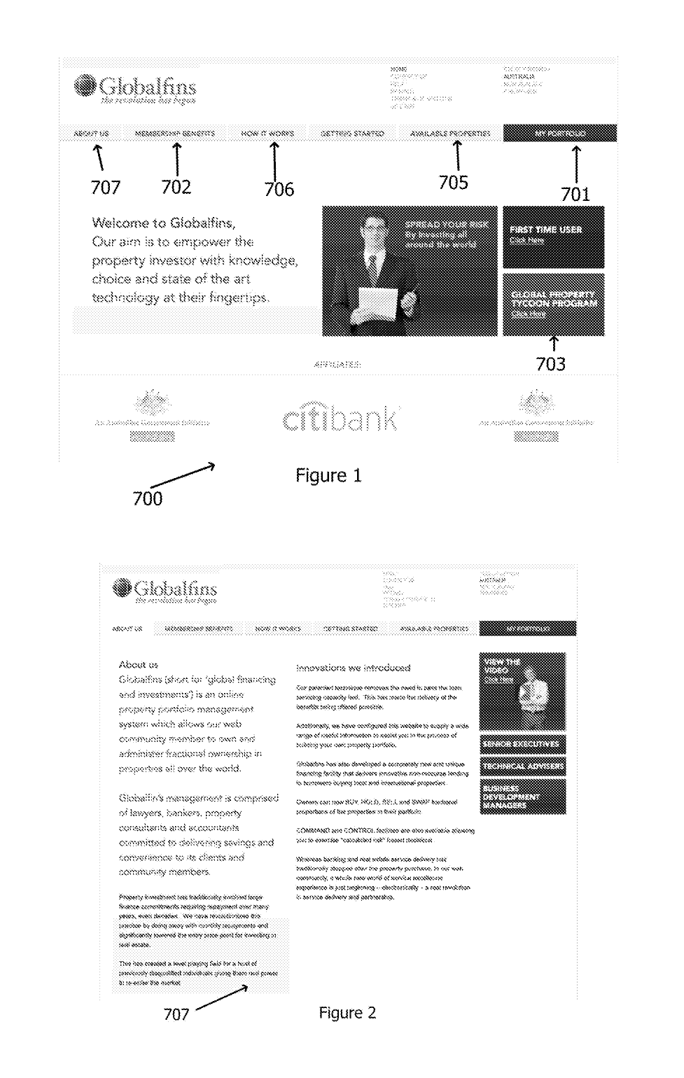

The Smart Mortgage product and incremental dollar risk index can be utilized over an Internet type environment for users. One example Internet type environment will now be discussed. Initially, turning to FIG. 1 illustrates a mockup home page template 700 which includes a number of clickable icons including icons which access: a user's property portfolio 701, an area highlighting membership benefits 702, general property reports 703, access to expert assistance, access to information on various property portfolios e.g. 705, and a general information area 706, an about us icon 707.

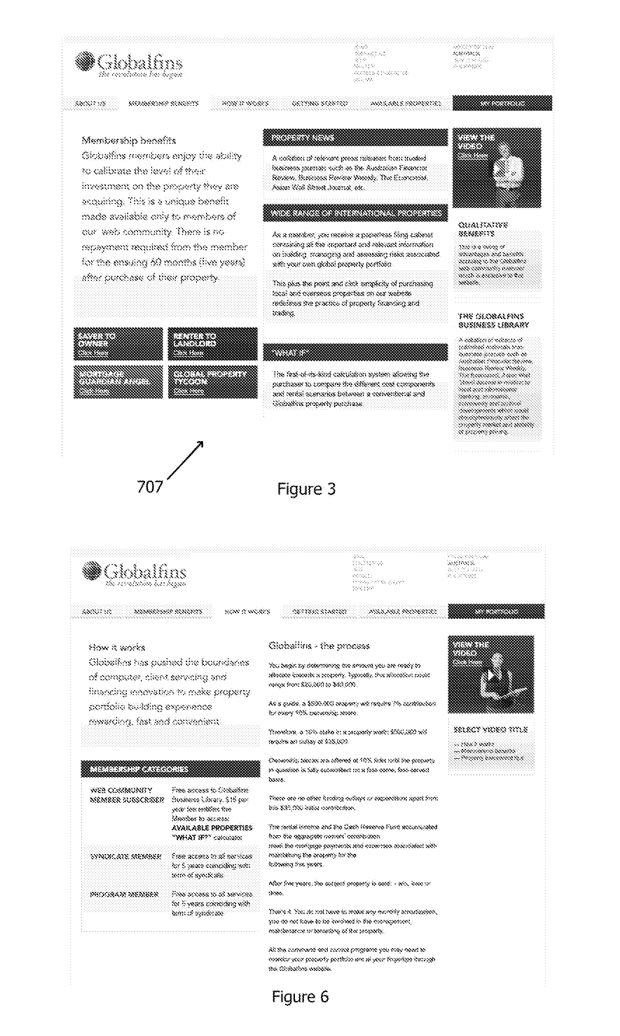

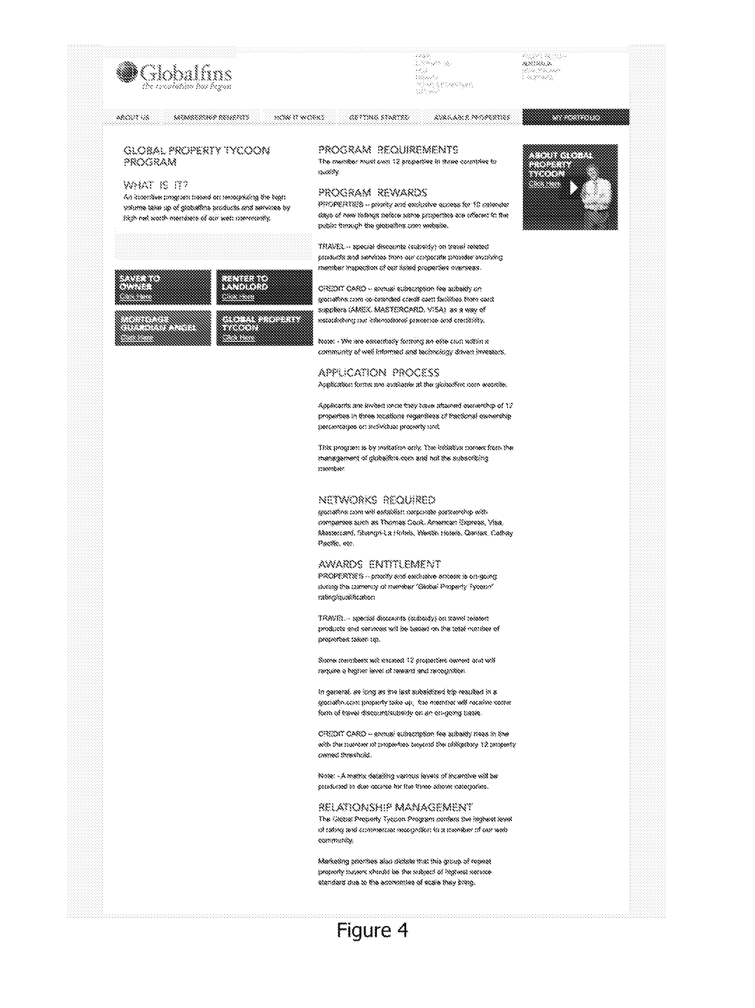

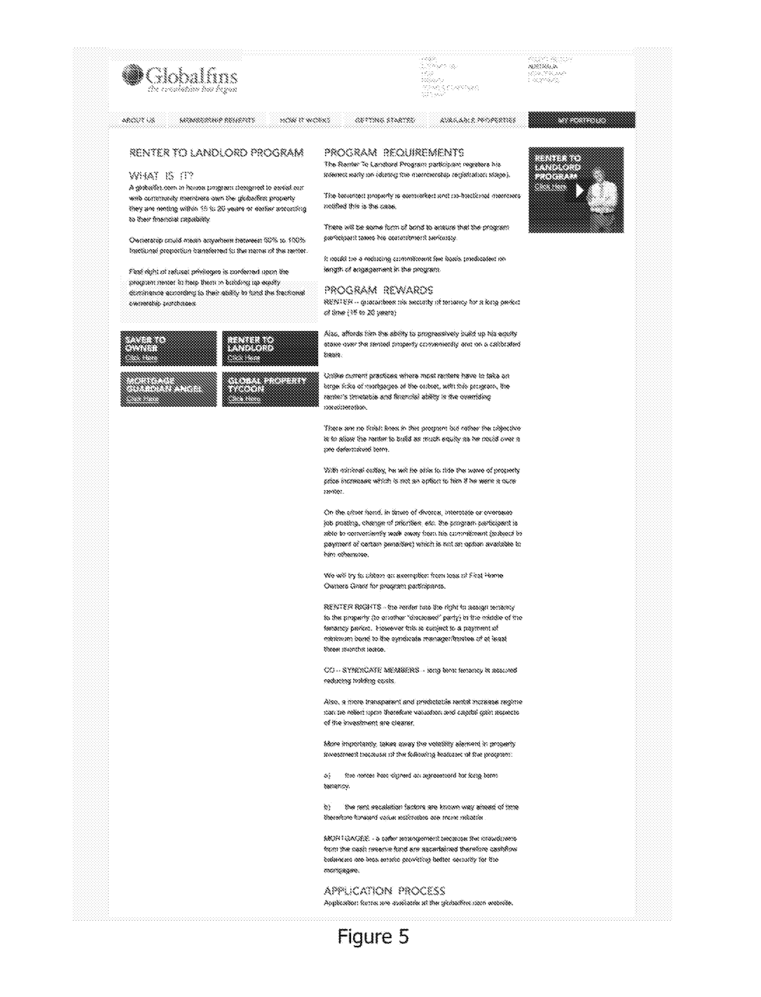

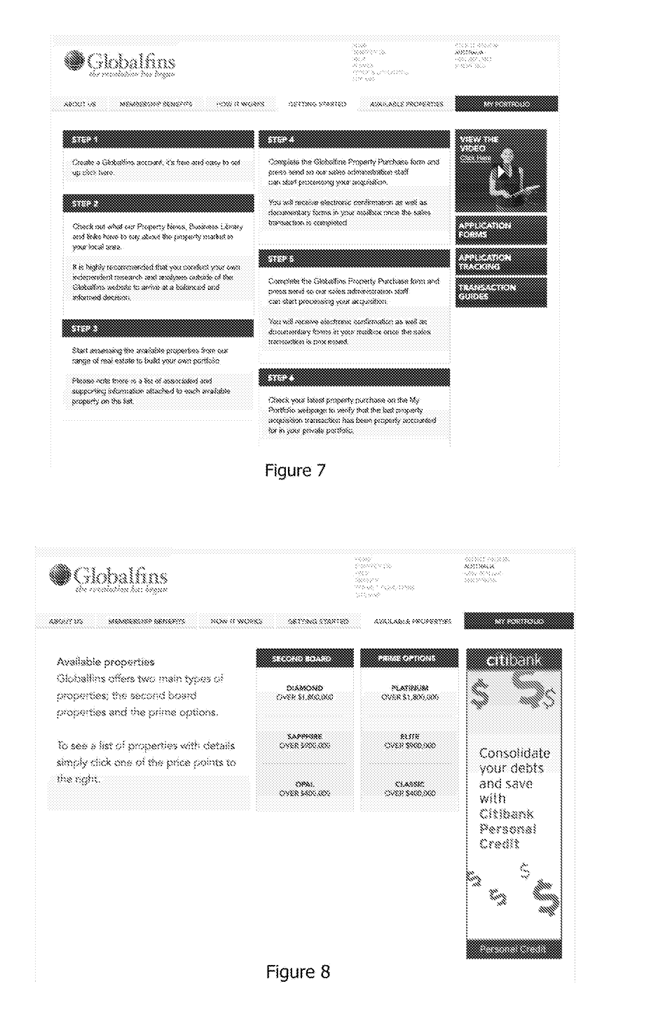

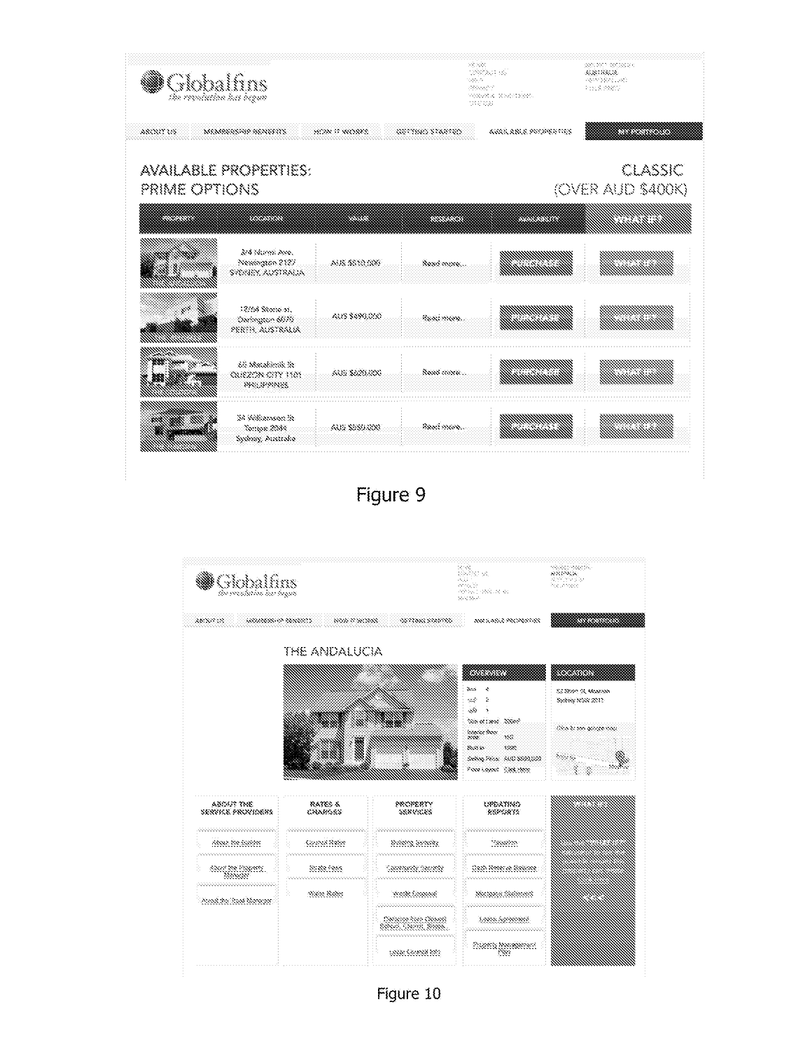

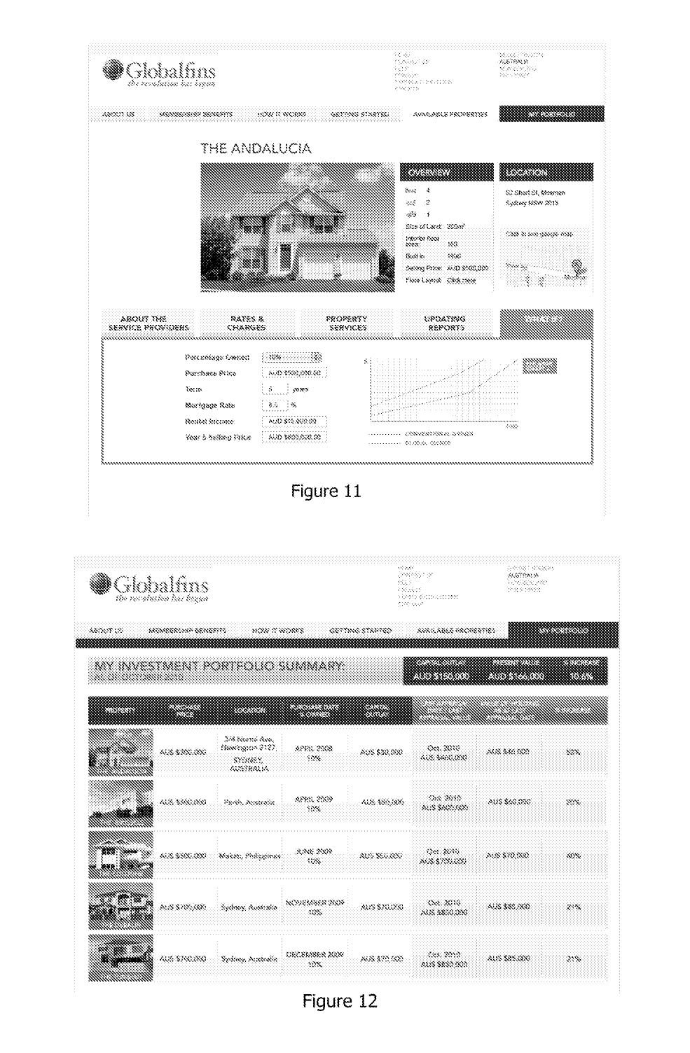

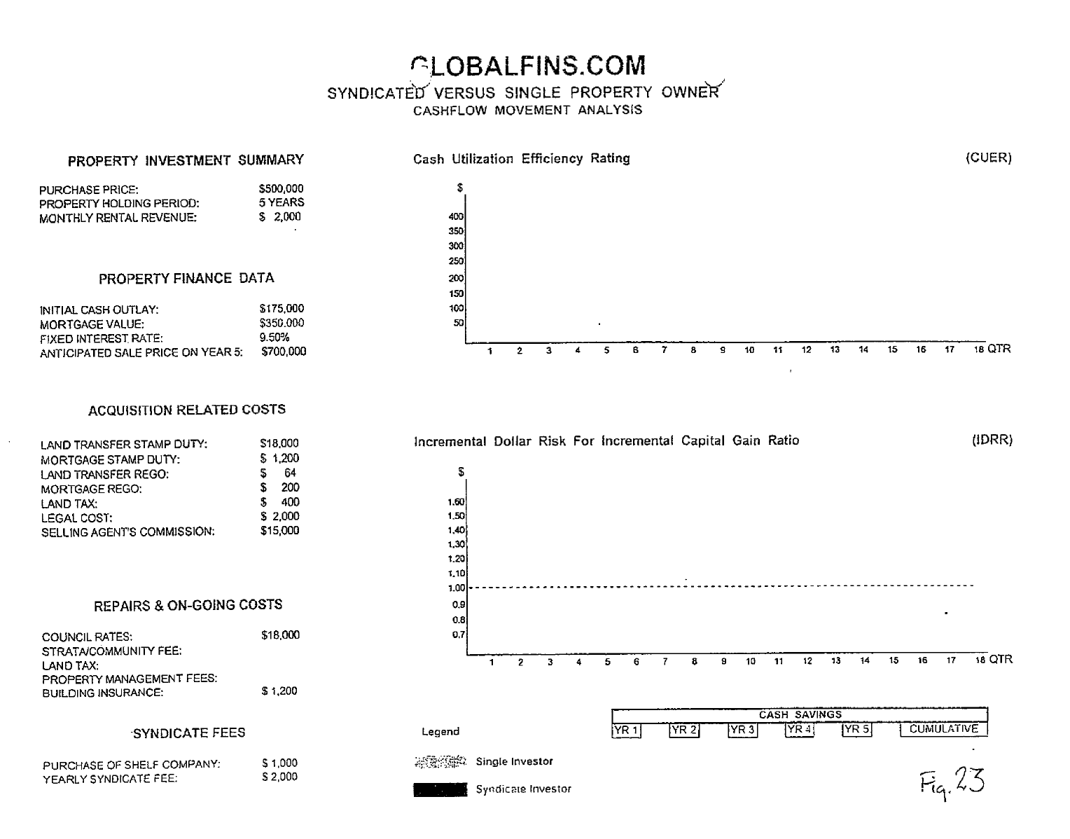

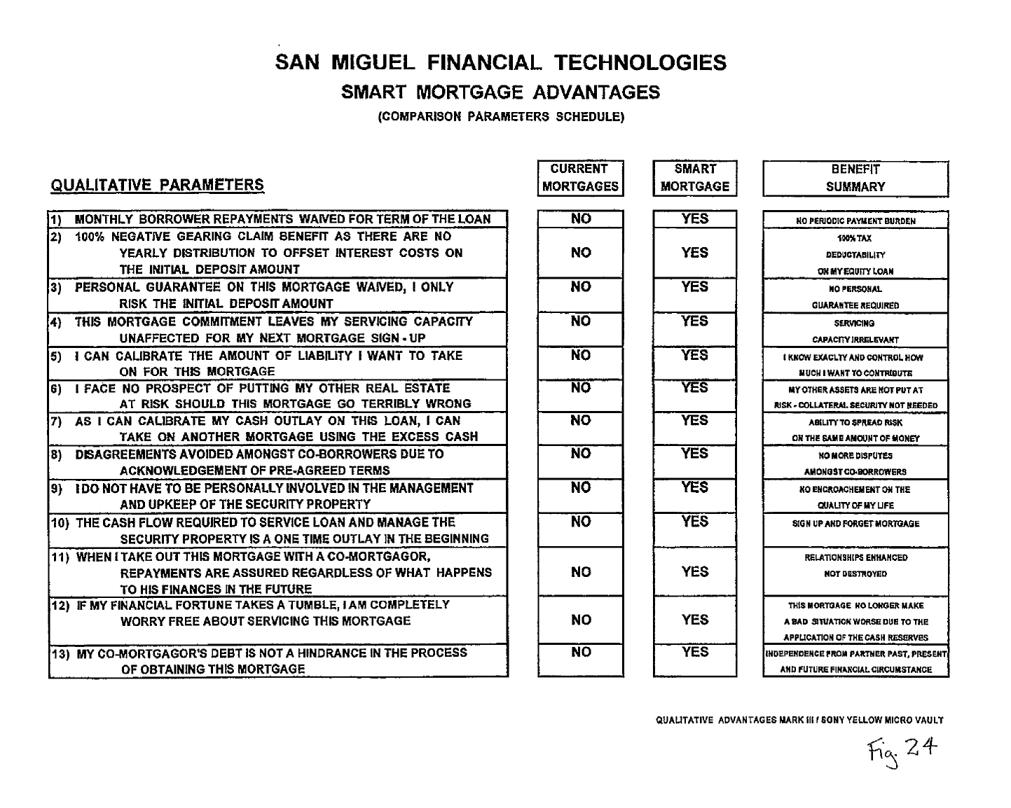

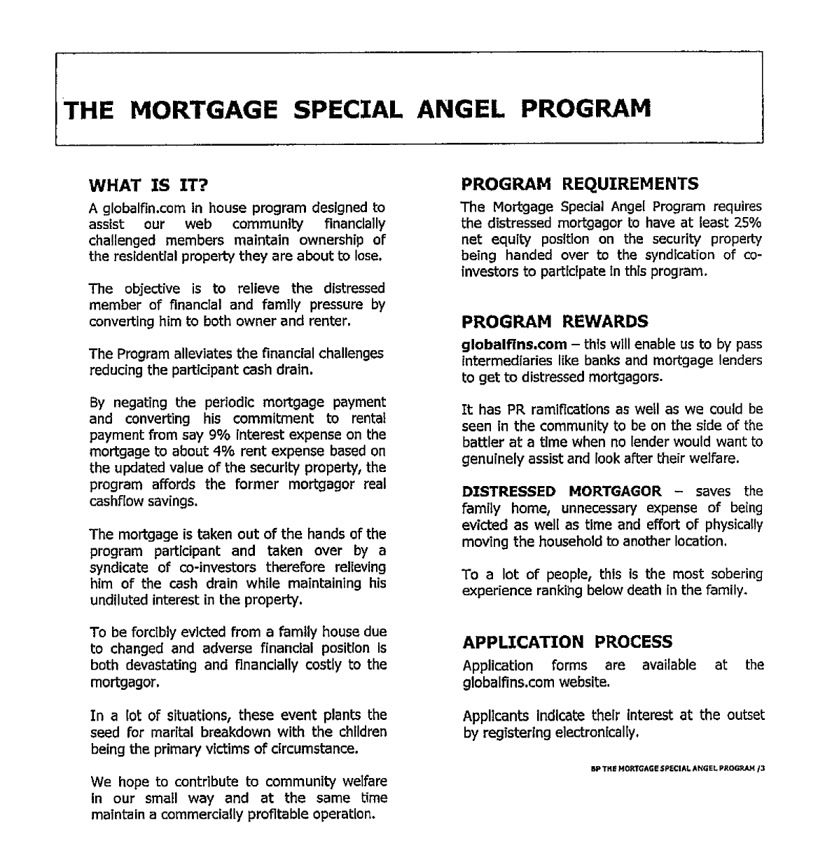

FIG. 2 illustrates an example mockup template design for the about us section 707 of the website. FIG. 3 provides a mockup template of the membership benefits section of the website. FIG. 4 illustrates an example incentive program section of the website. FIG. 5 illustrates the renter to landlord program part of the website. FIG. 6 illustrates a mockup of the “How it Works” part of the website. FIG. 7 illustrates a mockup of the “getting started” part of the website. FIG. 8 illustrates an example of the “available properties” portion of the website. FIG. 9 illustrates more specific of available properties. FIG. 10 and FIG. 11 illustrates an example mockup of a single property, providing details thereof. FIG. 12 provides an example mockup of a single user's investment portfolio.

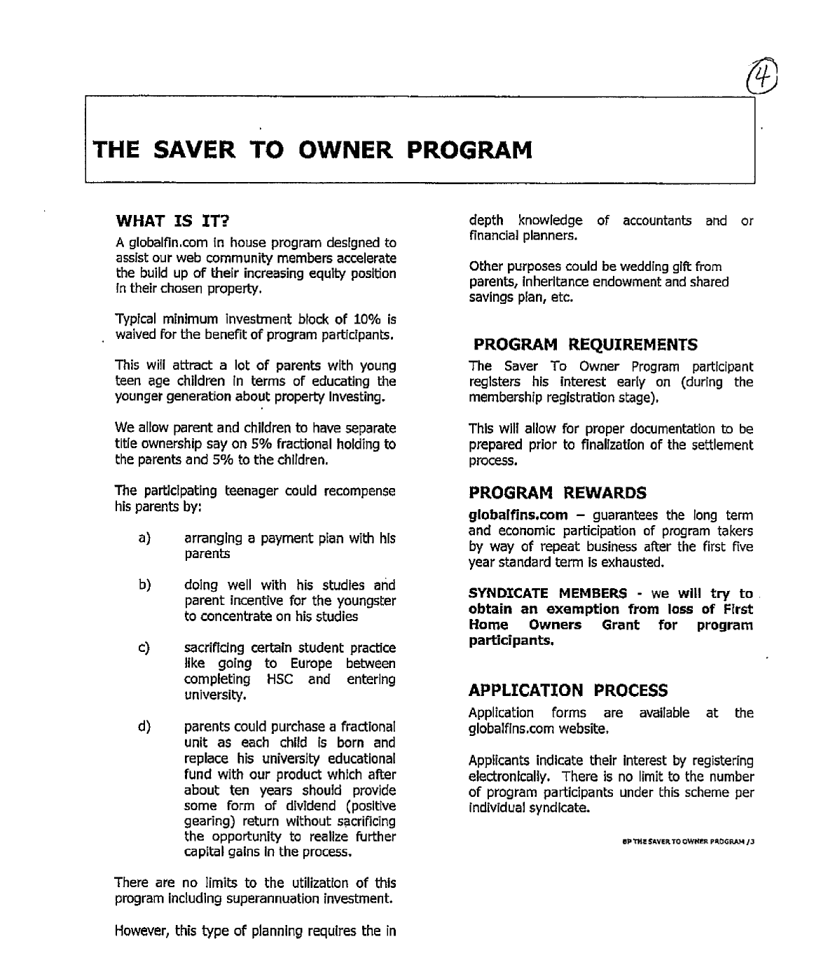

In another part of the website, a detailed discussion of the Incremental Dollar Risk index can be provided allowing a user to plot complex what if scenarios. One example analysis page is illustrated in FIG. 13 which shows various incremental Dollar Risk profiles for a user to review.

FIG. 15 is a comparison chart listing the comparative advantages of mortgages taken out in accordance with the Smart Mortgage system of the preferred embodiment.

As part of the website promotion, various “incentive programs”. Appendix A provides example information on each of the incentive programs, including a “Global Property Tycoon” program, a “Renter to Landlord” program and a “Saver to Owner” program. Of course, other incentive programs can also be developed on demand.

The forgoing describes preferred features of the present invention. Modifications, obvious to those skilled in the art, can be made thereto without departing from the scope of the invention.

1. A method of comparing at least two purchase scenarios, the method comprising the steps of:
determining a first cash flow analysis for a first mortgage scenario including a takeup of a first percentage of ownership of a mortgaged property;
determining a potential first capital gain attributable to the first percentage of ownership;
determining a second cash flow analysis for a second mortgage scenario for the same property with the second scenario having a takeup of a second percentage of ownership of the mortgage property;
determining a potential second capital gain attributable to the second percentage of ownership;
determining a first difference between the first and second cash flows;
determining a second difference between the first and second capital gains, and
determining the ratio of the second difference to the first difference.

2. A method as claimed in claim 1 wherein the potential capital gains determined may be real or unrealised capital gains.

3. A method as claimed in claim 1 wherein the amounts contributed in the first and second scenarios of a comparison are different.

4. A method as claimed in claim 1 wherein the interest rates for the mortgages in the first and second scenarios of a comparison are different.

5. A method as claimed in claim 1 wherein the total amounts borrowed for the mortgages in the first and second scenarios of a comparison are different.

6. A method as claimed in claim 1 including carrying out multiple comparisons and comparing the ratios obtained.

7. A method as claimed in claim 6 wherein one or both of the scenarios in each comparison is varied by varying at least one of:
the potential capital gain
possible expenses incurred whilst holding the property
possible income obtained whilst holding the property
period holding the property
borrower contribution
lender contribution
first percentage of ownership
second percentage of ownership,

8. A method as claimed in claim 6 wherein the period holding the property and potential capital gain are varied whilst other variables remain unchanged between comparisons.

9. A method as claimed in claim 1 wherein at least one of the mortgage scenarios is for a predetermined period and includes a cash reserve buffer for meeting expected outgoings during the life of the mortgage.

10. A method of selecting an ownership structure for purchase of a property from a plurality of possible ownership structures, the method comprising performing the method of claim 1 and selecting one of said ownership structures for the purchase of said property.

11. A web site for selecting an ownership structure for purchase of a property from a plurality of possible ownership structures, the website including:
a first user input for selection of a first mortgage scenario including a takeup of a first percentage of ownership of a mortgaged property;
means for determining a potential first capital gain attributable to the first percentage of ownership;
a second user input for a selection of a second mortgage scenario for the same property with the second scenario having a takeup of a second percentage of ownership of the mortgage property;
means for determining a first cash flow analysis for said first mortgage scenario;
means for determining a potential first capital gain attributable to the first percentage of ownership;
means for determining a second cash flow analysis for said second mortgage scenario;
means for determining a potential second capital gain attributable to the second percentage of ownership;
means for determining a first difference between the first and second cash flows;
means for determining a second difference between the first and second capital gains, and
means for determining the ratio of the second difference to the first difference and displaying said ratio on said web site.

12. The web site of claim 11 including means to allow the user to vary the amount contributed in one or both of the first and second scenarios of a comparison.

13. The web site of claim 11 including means to allow the user to vary the interest rate for the mortgage in one or both of the first and second scenarios of a comparison.

14. The web site of claim 11 including means to allow the user to vary the total amount borrowed for the mortgage in one or both of the first and second scenarios of a comparison.

15. The web site of claim 11 including means to allow the user to carrying out multiple comparisons and to simultaneously display the multiple ratios obtained.

16. The web site of claim 11 including means to allow the user to vary at least one of:
the potential capital gain
possible expenses incurred whilst holding the property
possible income obtained whilst holding the property
period holding the property
borrower contribution
lender contribution
first percentage of ownership
second percentage of ownership,
for one or both of the scenarios in each comparison

17. The web site of claim 11 including user input area to enable a user to select one of said ownership structures, and for indicating a desire, willingness or commitment to purchasing said property with said selected ownership structure.

18. A property portfolio management website including at least:
a first accessible area including details of a user's actual property investments, the actual property investments including a predetermined percentage of a mortgaged property;
a second accessible area including details of available property investments;
a third accessible area showing a measure of simulated incremental dollar risk for an incremental dollar gain for a potential property investment.

19. A property portfolio management website as claimed in claim 18 further including at least one of:
a property outlook area providing information on projected property outlooks for particular areas;
a question asking area for asking questions about property matters; or
an incentive program system offering predetermined incentives for take up of available property investments.

20. (canceled)

21. (canceled)
